(19) United States
(12) Patent Application Publication
(10) Pub. No.: US 2025/0257226 A1
(43) Pub. Date: Aug. 14, 2025

(54) ROOF COATING RESISTANT TO BIOFOULING

(71) Applicants: Dow Global Technologies LLC, Midland, MI (US); Rohm and Haas Company, Collegeville, PA (US); Dow Silicones Corporation, Midland, MI (US)

(72) Inventors: Graham P. Abramo, Penllyn, PA (US); Ashish Jayaraman, Conchohocken, PA (US); Victoria A. Demarest, Flourtown, PA (US); William J. Fabiny, Harleysville, PA (US); Milton H. Repollet Pedrosa, Midland, MI (US)

(21) Appl. No.: 18/857,514

(22) PCT Filed: Apr. 27, 2023
(86) PCT No.: PCT/US2023/066287

§ 371 Date: Oct. 17, 2024

Related U.S. Application Data
(60) Provisional application No. 63/337,233, filed on May 2, 2022.

(51) Int. Cl. C09D 5/16; C09D 7/40; C09D 7/65; C09D 133/04; E04D 7/00; E04D 13/00

(52) U.S. Cl. CPC C09D 5/1637; C09D 5/1668; C09D 7/65; C09D 7/69; C09D 133/04; E04D 7/00; E04D 13/002

(57) ABSTRACT

Biofouling of roof structures is reduced by applying to the roof a coating composition that contains an acrylic binder and a non-toxic antifouling additive that interferes with the ability of biofoulants to attach to the coating. Examples of non-toxic antifouling additives include polysiloxanes and cross-linked silicone rubbers.

### FIELD

The present invention relates to the art of roofing systems.

### INTRODUCTION

Biofouling is a well-known problem in many contexts. Bacteria, algae, molds, mildews and more complex organisms attach and grow on ships, docks, homes and other structures. The growth can interfere with the function of the structure on which it occurs and can damage the surface on which it occurs.

Biofouling problems are widespread on roofs. Roof surfaces may comprise many different materials, such as shingles, ceramic tiles, metal roofing, polymer membranes or built up roofing which is made of layers of asphalt and reinforcing material. Roof surfaces may also have different angles from horizontal or “pitch.” Some roofs have a pitch of 10 degrees or less (no more than 2 horizontal feet per 12 vertical feet) and are considered low-pitch roofs. Some roofs are essentially horizontal and are considered flat roofs. Shingles and ceramic tiles are commonly used in roofs with a pitch over 10°, whereas metal and membranes are commonly used in low-pitch or horizontal roofs. Built up roofing is common only in flat roofs. Examples of common membranes contain ethylene propylene diene terpolymer (EPDM), thermoplastic polyolefin (TPO) and polyvinyl chloride.

Roofs, and especially low-pitch and flat-roofs, are often coated with a coating composition to provide additional protection to the roof substrate. The coating composition often contains a white pigment to reflect sunlight, in order to reduce heating of the structure under the roof and conserve energy.

All roofs are susceptible to growth of biofouling organisms, such as bacteria, algae, molds and mildews and other organisms. Flat roofs are more susceptible because they can contain standing pools of water after a rainstorm. Biofouling organisms stain the light-colored surface of the roof and increase the solar energy that it absorbs. Further, biofouling organisms can adhere strongly to a roof and cause failures in the coating through repeated wet and dry cycles.

A common way to deal with biofouling of roofs is to wash the roof with a biocide that kills to biofouling organisms. Sodium hypochlorite (bleach) solutions are commonly used for this purpose. This approach is undesirable for several reasons. It is labor-intensive. It requires cleaners to work on the roof, which can damage the roof and is dangerous on a pitched roof. It is a temporary solution and must be repeated regularly. It requires the use of large quantities of biocide on the roof; the biocide eventually washes off the roof and can damage desirable plants around the structure or enter the ecosystem.

What is needed is a longer-term, environmentally-friendly solution to biofouling on roofs.

### SUMMARY

Antifouling coatings are divided into two groups: toxic and non-toxic. Toxic antifouling coatings contain a biocidal additive that is released over time and kills biofouling organisms adhering to the coating. Examples of biocidal additives include 4,5-dichloro-2-octyl-4-isothiazolin-3-one (DCOIT), 2 n octyl-4-isothiazolin-3-one (OIT) and zinc pyrithione (ZPT). Non-toxic antifouling coatings are formulated to prevent biofouling organisms from attaching to the coating. Biofouling organisms that cannot attach to a solid surface often are unable to substantially grow or reproduce and do not create biofouling problems.

One aspect of the present invention is a method to protect the roof of a structure, which has an exposed top surface, comprising the steps of
a. applying to the top surface of the roof an aqueous coating composition that contains the following coating components dissolved or suspended in an aqueous solvent:
   i. an acrylic polymer binder in a concentration suitable to form a stable coating,
   ii. a non-toxic antifouling additive in a concentration suitable to suppress fouling on the roof, and
   iii. from 0 to 80 weight percent other coating components based on the weight of the coating components in the composition, excluding solvent; and
b. drying the aqueous coating composition such that it forms a solid coating adhered to the top surface of the roof.

A second aspect of the present invention is an aqueous coating composition useful in method of the present invention, which coating composition comprises the following coating components dissolved or suspended in an aqueous solvent:
a) An acrylic polymer binder that has a glass-transition temperature of no more than 0° C., in a concentration suitable to form a stable coating;
b) a non-toxic antifouling additive in a concentration suitable to suppress fouling on the roof; and
c) from 0 to 80 weight percent other coating components based on the weight of the coating components in the composition, excluding solvent.

A third aspect of the present invention is a structure comprising a roof with an exposed top surface, wherein a solid coating is adhered to the top surface of the roof and the coating contains the following coating components: (a) an acrylic polymer binder that has a glass-transition temperature of no more than 0° C. and binds the coating to the roof; (b) a non-toxic antifouling additive in a concentration suitable to suppress fouling on the roof; and (c) from 0 to 80 weight percent other coating components based on the weight of the coating components in the composition, excluding solvent.

Using the present invention, biofouling of roofs can be suppressed, extending both the life of the roof and the ability of the roof to reflect energy, without introducing unnecessary biocides into the environment.

### DETAILED DESCRIPTION

The present invention uses an aqueous coating composition that comprises an acrylic binder and a non-toxic antifouling additive. In some embodiments, the aqueous coating composition may also contain other components such as pigments, thickeners, surfactants, hydrophobic additives, levelling and coalescing agents, antioxidants, UV stabilizers, fillers or other additives known for out-door coatings.

### Solvent

The coating composition contains an aqueous solvent. The term “solvent” does not imply that all coating components of the composition are soluble in or dissolved in the solvent; some or all of the coating components may be suspended in the solvent as a suspension or emulsion, with or without emulsifying agents. In some embodiments, the pH of the aqueous solvent is at least 5 or at least 5.5 or at least 6 or at least 6.5 or at least 6.75 or at least 6.9. In some embodiments, the pH of the aqueous solvent is at most 9.8 or at most 8.5 or at most 8 or at most 7.7 or at most 7.5 or at most 7.2.

### Binder

The coating composition contains an acrylic polymer binder. Acrylic polymer binders and their dispersions are known, and they are commercially available. They are described in publications such as “Paints” published by Department of Chemistry, University of York at https://www.essentialchemicalindustry.org/materials-and-applications/paints.html (Mar. 18, 2013).

An acrylic polymer is a polymer or copolymer that contains repeating units derived from acrylic monomers. Acrylic monomers include acrylic acid, methacrylic acid and their esters. Exemplary esters used in acrylic monomers include alkyl esters such as alkyl groups containing from 1 to 8 carbon atoms or from 1 to 4 carbon atoms or in some cases methyl groups or ethyl groups. Particularly useful acrylic monomers are acrylic acid, methacrylic acid, butyl acrylate, 2 ethylhexyl acrylate, methyl acrylate, ethyl acrylate, methyl methacrylate and ethyl methacrylate.

Exemplary acrylic polymers may contain at least 70 weight percent repeating units derived from acrylic monomers, or at least 80 weight percent or at least 90 weight percent or at least 95 weight percent. Exemplary acrylic polymers may contain up 100 percent repeating units derive derived from acrylic monomers. Some exemplary acrylic polymers are copolymers containing units derived from two or more acrylic monomers, such as copolymers of butyl acrylate with methyl methacrylate and/or methacrylic acid. Some exemplary acrylic polymers may further contain repeating units derived from non-acrylic ethylenically unsaturated comonomers, such as vinyl acetate and similar vinyl esters or styrene.

The selection of acrylic monomers and their proportions are governed by the intended use of the acrylic polymer. Binders that are used in roof coatings may be subjected to thermal expansion and contraction under cold temperatures. The acrylic binder may be selected to have a low Tg such as at most 0° C. or −10° C. or −15° C. or −20° C. or 30° C. or 40° C. There is no minimum desirable Tg, but Tg below −60° C. are seldom necessary.

Increasing content of certain monomers such as methyl methacrylate is known to increase Tg of the resulting polymer, and increasing content of other monomers such as butyl acrylate is known to reduce Tg of the resulting polymer. In some embodiments, the acrylic polymer binder contains at least 7 weight percent units derived from methyl methacrylate or at least 10 weight percent or at least 12 weight percent. In some embodiments, the acrylic polymer binder contains at most 50 weight percent units derived from methyl methacrylate or at most 45 weight percent or at most 40 weight percent. In some embodiments, the acrylic polymer binder contains at least 50 weight percent units derived from butyl acrylate or at least 55 weight percent or at least 60 weight percent. In some embodiments, the acrylic polymer binder contains at most 93 weight percent units derived from butyl acrylate or at most 90 weight percent or at most 88 weight percent.

In some embodiments, the particles of acrylic polymer binder have an average diameter of at least 50 nm or at least 100 nm or at least 200 nm. In some embodiments, the particles of acrylic polymer binder have an average diameter of at most 700 nm or at most 500 nm or at most 400 nm.

In coatings for roofing applications, it may also be useful for the acrylic polymer binder to remain non-molten in temperatures that roofs are commonly exposed to. In some embodiments, the acrylic polymer binder has a melting temperature of at least 60° C. or at least 75° C. or at least 80° C. or at least 95° C. or at least 110° C. There is no maximum desirable melting temperature, but temperatures above 200° C. are seldom necessary.

In coatings for roofing applications, it may also be useful for the acrylic binder to be stable under ultraviolet light. In some embodiments, the acrylic binder contains essentially no aryl groups, such as avoiding phenyl esters of acrylic and methacrylic acid.

Binders are typically film-forming under the conditions at which they are applied to the intended substrate. “Film-forming” means that a substance is capable of forming a film upon application to a solid surface. The ability of polymers and their solutions or emulsions to be film-forming is known and described in publications such as: P. A. Steward et al., “An Overview of Polymer Latex Film Formation and Properties”, 86 Advances in Colloid and Interface Science at 195-267 (2000) and J. Guerts et al., “New Waterborne Acrylic Binders for Zero VOC Paints”, 5 J. Coating Technol. Res. at 57-63 (2008). Commonly, the film-forming ability of polymers increases with lower molecular weight and/or lower Tg and decreases with higher molecular weight and/or higher Tg.

In coatings for structural and outdoor applications, binders may be selected to be insoluble in water, so that the coating remains stable in rain and humidity.

In the coating composition, the binder particles are suspended in an aqueous dispersion. In some embodiments, the binder particle contains surface modifications to prevent particles from agglomerating or the dispersion contains a dispersing agent (also called a dispersant) to prevent particles from agglomeration. For example, in some embodiments, the collection of charged moieties at the surface of the binder particles may inhibit agglomeration of the binder particles. The charge on the surface of particles can be measured by zeta-potential, as described in “Zeta Potential—An Introduction in 30 Minutes”, published by Malvern Panalytical (2010) and available at https://www.malvernpanalytical.com/en/. In some embodiments, the zeta potential of the binder particles in suspension is at least 30 mV or at least 40 mV or at least 50 mV or at least 60 mV. It is known to increase zeta potential for polymer particles by incorporation of polarized monomers into the polymer that collect preferentially on the surface of the polymer particle. In some embodiments, the dispersion contains a dispersing agent such as a surfactant to stabilize the particles and prevent agglomeration. In some embodiments, the surfactant is a non-ionic surfactant.

Examples of binders that are commercially available include acrylic polymers and polymer dispersions available from the Dow Chemical Company under the RHOPLEX™, PARALOID™, and MAINCOTE™ trademarks.

The binder is present in the coating composition in a concentration suitable to adhere the coating components of the composition to a substrate that the composition is applied to. In some embodiments, the binder makes up at least 20 weight percent of the coating components in the composition (excluding solvent) or at least 25 weight percent or at least 35 weight percent or at least 45 weight percent. In some embodiments, the binder makes up at most 80 weight percent of the coating components in the composition (excluding solvent) or at most 70 weight percent or at most 60 weight percent.

(“Coating components” are the non-volatile components of the aqueous coating composition other than the solvent, which are expected to be deposited on the roof and become part of the roof coating. The binder, the non-toxic anti-fouling additive and other components listed below are coating components. In many cases, they are solid or glassy-solid at room temperature, when they are not dissolved or suspended in a solvent, and they are commonly referred to as “solids”.)

### Non-Toxic Antifouling Additive

Compositions useful in the present invention also contain a non-toxic antifouling additive. Without intending to be bound, we hypothesize that the non-toxic antifouling additive reduces the ability of biofouling organisms to attach to the surface of the coating. Examples of non-toxic antifouling additives include:
a. Polysiloxanes,
b. Cross-linked silicone rubber particles, and
c. Fluorinated polymers.

In some embodiments, the antifouling additive is a silicon-containing material, such as a polysiloxane or cross-linked silicone rubber.

Polysiloxanes are known and commercially-available. Polysiloxanes are oligomers or 5 polymers characterized by the repeating unit:

—(—SiR¹R²—O—)ₙ—

wherein each of R¹ and R² is independently an organic moiety and n is a number of repeating units. In some embodiments, each R group is a relatively non-reactive organic group such as an unsubstituted or halogenated alkyl, aryl or alkaryl group. For example,.
One or both R groups may independently be alkyl or fluorinated alkyl, and in some embodiments the alkyl or fluorinated alkyl groups may contain from 1 up to 8 or up to 6 or up the 4 carbon atoms. In some embodiments, each R group is independently a methyl or trifluoromethyl group.
One or both R groups may independently be phenyl or alkyl-substituted phenyl groups. such a dimethyl phenyl or trimethyl phenyl. In some embodiments, aryl groups may be avoided to improve light stability of the siloxane

In some embodiments, the polysiloxane forms a ring, such as a ring containing 3 or 4 of the repeating units illustrated above. In some embodiments, the polysiloxane forms a substantially linear chain capped at the end with an —OH or —OR3 moiety, wherein R3 is an organic moiety as previously described.

In some embodiments, the average degree of polymerization (n) is at least 3 or at least 10 or at least 50 or at least 90. In some embodiments, the average degree of polymerization is at most 10,000 or at most 7000 or at most 5000 or at most 4000. In some embodiments, the weight average molecular weight of the polysiloxane is at least 700 Da or at least 1500 Da or at least 3000 Da or at least 5000 Da. In some embodiments, the weight average molecular weight of the polysiloxane is at most 700,000 Da or at most 500,000 Da or at most 350,000 Da or at most 300,000 Da or at most 220,000 Da. Many polysiloxanes are liquid at room temperature, and their degree of polymerization can be inferred from their viscosity. In some embodiments, a polydimethylsiloxane may have a viscosity of at least 4 cSt or at least 10 cSt or at least 25 cSt or at least 80 cSt. In some embodiments, a polydimethylsiloxane may have a viscosity of at most 3,000,000 cSt or at most 1,500,000 cSt or at most 1,000,000 cSt or at most 500,000 cSt or at most 350,000 cSt.

In some embodiments, the polysiloxane has a low glass transition temperature (Tg), such as no more than −50° C. or −75° C. or −100° C. or −125° C.

In some embodiments, the polysiloxane is hydrophobic.

In some embodiments, the polysiloxane has low surface tension and is capable of wetting surfaces. For example, the surface tension may be at most 40 mN/m or at most 30 mN/m or at most 25 mN/m or at most 21 mN/m.

Appropriate polysiloxanes can be made by condensing a dichlorosilane in the presence of excess water as described in Treatise on Coatings Vol 1, Part III (Film Forming Composition). Edited by Raymond R. Myers and J. S. Long. Published by Marcel Dekker, Inc. New York 1972.

Many appropriate polysiloxanes are insoluble in water; they may be maintained in the solvent as an emulsion with emulsifiers. Emulsifiers maintain insoluble liquids in suspension in an aqueous solvent. Emulsifiers are generally surfactants, such as anionic and nonionic surfactants. For example, some common emulsifiers are fatty alkyl sulfates such as sodium lauryl sulfate, alcohol ether sulfates, aryl sulfonates such as branched sodium dodecyl benzene sulfonate, alkyldiphenyloxide disulfonates such as disodium lauryl phenyl ether disulfonate, nonylphenol ether sulfates such as ammonium nonylphenol ether sulfate, fatty alcohol ethoxylates, nonylphenol ethoxylates, or alkyl phosphate esters such as ammonium phosphate, polyoxyethylene tridecyl ether. Suitable emulsifiers are available under the trademarks DOWSIL™, TERGITOL™, TRITON™, RHODAFAC™, RHODACAL™, DISPONIL™, Lutensol and DOWFAX™.

Appropriate polysiloxanes and polysiloxane emulsions are commercially available, such as under the trademarks: DOWSIL™ 8004, DOWSIL™ 84 additive, DOWSIL™ 910H and DOWSIL™ 8005. One commonly available polysiloxane that can be used is polydimethylsiloxane, which is often abbreviated PDMS. PDMS is commercially available under the trademark XIAMETER™.

Cross-linked silicone rubber particles and their emulsions are also known and commercially available. Cross-linked silicone rubber particles are commonly made by emulsifying a liquid polysiloxane polymer and cross-linking it using a cross-linking agent. Such processes are described in publications such as the following U.S. Pat. Nos. 5,708,057; 6,433,041; and 6,710,124 B2.

The polysiloxane polymer may meet the broad description previously given. In some embodiments, the polysiloxane polymer may have lower viscosity and molecular weight in the named ranges before cross-linking.

Different cross-linking agents and systems are also known.
In some embodiments a peroxide catalyst, such as dichlorobenzoyl peroxide or dicumyl peroxide, causes direct free-radical cross-linking of unsaturated organic moieties on different polysiloxane chains. An example of this reaction is described in US Patent Publication 2022/0049097 A1. This reaction typically takes place at an elevated temperature such as 80° C. to 200° C.
In some embodiments, the polysiloxane has vinyl moieties that can cross-link in the presence of a platinum group catalyst, such as platinum, rhodium, palladium, or their oxides. An example of this polymerization is described in PCT Patent Publication WO 2021/262497, and useful catalysts are particularly described in Paragraphs [0033] to of [0037] that publication. This reaction commonly takes place at room temperature.
In some embodiments, the cross-linking is accomplished by condensation of hydrolysable groups on the polysiloxane, using a hydrolysable cross-linker such as methyl trimethoxy silane or methyl triacetoxysilane. The hydrolysable groups on the polysiloxane and the cross-liner are hydrolyzed by water in the presence of a catalyst such as dibutyl tin dilaurate, and the hydrolyzed groups condense and cross-link the polymers as the emulsion is dried. This reaction commonly takes place at room temperature.

In some embodiments, the cross-linked silicone rubber particles have an average particle diameter of at least 0.1 μm or at least 0.5 μm or at least 1 μm. In some embodiments, the cross-linked silicone rubber particles have an average particle diameter of at most 5 μm or at most 3 μm or at most 1.5 μm.

In some embodiments, the glass-transition temperature (Tg) of the rubber particles is similar to the Tg already described for the siloxanes.

The rubber is typically suspended in the coating composition as a dispersion, which may use dispersing agents as previously described. Examples of suitable cross-linked rubber dispersions are commercially available under the DOWSIL™ trademark.

Fluorinated polymers that are suitable for antifouling coatings are known and described in publications such as Nurioglu et al., Non-Toxic, Non-Biocide-Release Antifouling Coatings Based on Molecular Structure Design for Marine Applications, 3 J. Mater. Chem B 6547 (2015) and Sun et al., Antifouling Surfaces Based on Fluorine-Containing Asymmetric Polymer Brushes: Effect of Chain Length of Fluorinated Side Chain, 35 Langmuir 1235 (2019). In some embodiments, a fluoropolymer dispersion is added to the coating. In some cases, a fluoropolymer side chain is grafted to another coating composition, such as a polyurethane binder.

Appropriate fluorinated polymers can be made by polymerization of the corresponding fluorinated ethylene monomer as described in U.S. Pat. No. 7,851,573 B2.

Appropriate fluoropolymers are commercially available, such as under the trademarks: Tedlar, Kynar, and Teflon.

The non-toxic anti-fouling additive is present in a concentration suitable to reduce biofouling on a roof surface. In some embodiments, the non-toxic anti-fouling additive makes up at least 2 weight percent of the coating components in the composition (excluding solvent) or at least 3 weight percent or at least 4 weight percent or at least 5 weight percent. In some embodiments, the non-toxic anti-fouling additive makes up at most 35 weight percent of the coating components in the composition (excluding solvent) or at most 25 weight percent or at most 20 weight percent. Antifouling additives that have a middle-range molecular weight or degree of polymerization may be highly effective in the lower end of the concentrations listed above, such as no more than 10 weight percent or no more than 8 weight percent. On the other hand, anti-fouling additives that have a very high or very low molecular weight or degree of polymerization may be more effective in the higher end of the concentrations listed above, such as at least 8 weight percent or at least 10 weight percent or at least 12 weight percent.

### Other Components

Aqueous compositions of the present invention may optionally contain other coating components and additives that are appropriate for roof coatings. Many such components are described in the publication Johan Bieleman (ed.), Additives for Coatings, published by WILEY-VCH Verlag GmbH (2000). Some examples of common additives are listed below. All of the additives listed below are commercially available.

The aqueous composition may optionally contain pigments, such as titanium dioxide or carbon black. For roofing applications, a white or reflective pigment such as titanium dioxide or metal flake may be selected to reflect solar energy and reduce solar heating of the building under the roof. Alternatively, in cold-weather climates a dark pigment such as carbon black may be selected to increase solar heating of the roof.

The aqueous composition may optionally contain thickeners to make it easier to handle and apply. Examples of thickeners include inorganic materials such as certain clays and polymer thickeners, such as certain cellulose derivatives, starches and acrylic polymers.

The aqueous composition may optionally contain surfactants for a number of purposes. Some surfactants are emulsifiers, wetting agents and dispersants, which help insoluble components to enter and remain in an emulsion or dispersion in the aqueous solvent. Some surfactants are antifoaming agents. Some surfactants can promote adhesion of the binder to the roof surface.

The aqueous composition may optionally contain hydrophobic additives to improve its ability resist water infiltration. Examples of hydrophobic components may include waxes and polymers such as polypropylene.

The aqueous composition may optionally contain levelling and coalescing agents to provide complete coverage and a smooth surface on the roof. Examples of levelling additives include certain polyacrylate polymers, which have a low glass-transition temperature such as −20° C. or lower. Coalescing agents promote interaction of binder molecules as the coating dries on the substrate, to form a solid homogeneous film that does not redissolve when subjected to new water. Examples of coalescing agents include.
certain branched and cyclic paraffins,
certain esters such as 3-hydroxy-2,2,4-trimethylpentyl isobutyrate (TPiB), diesters of adipic acid (ADE), dimethyl phthalate (DMP), 2-hydroxypropyl ethylhexanoate (HPE) and benzyl benzoate, and
certain ether alcohols such as ethylene glycol butyl ether, propylene glycol butyl ether, dipropylene glycol butyl ether (DPB) and propylene and ethylene glycol phenyl ether (PPH and EPH

The aqueous composition may optionally contain antioxidants. Antioxidants may include a primary antioxidant such as certain amines or sterically-hindered phenols and/or a secondary antioxidant such as certain organophosphates or thioesters.

The aqueous composition may optionally contain light and ultraviolet (UV) stabilizers. Examples of light and ultraviolet (UV) stabilizers may include:
UV absorbers such as benzotriazoles and other compounds having coordinated double bonds; and
Sterically-hindered amines such as compounds containing a 2,2,6,6-tetramethylpiperidine group;

The aqueous composition may optionally contain fillers. Fillers are solid particles added to a coating to improve properties and/or reduce cost. Suitable fillers for coatings are known and commercially available. Examples of suitable fillers include clays such a kaolin, diatomaceous earth, glass powder and microspheres, aluminum hydroxide and various powdered minerals such as calcium carbonate, dolomite, feldspar, mica, quartz, silica and silicates, talc and metal carbonates. Fillers and their production and use are described in publications such as: Gysau, Fillers for Paints (3rd Ed.), Vincentz Network GmbH & Co. (2017); and “Functional Silicate Fillers: Basic Principles”, Painting & Coatings Industry (Aug. 1, 2002) (https://www.pcimag.com/articles/84909-functional-silicate-fillers-basic-principles).

The other coating components may make up 0 to 80 weight percent of the coating composition, excluding solvent. The concentration of pigments and fillers may optionally be relatively high as compared to the binder and non-toxic antifouling additive. In some embodiments, the pigments and fillers make up at least 20 weight percent of the coating components in the composition (excluding solvent) or at least 30 weight percent or at least 40 weight percent. In some embodiments, the pigments and fillers make up at most 80 weight percent of the coating components in the composition (excluding solvent) or at most 75 weight percent or at most 65 weight percent.

The concentration of other additive components may optionally be lower as compared with the binders and pigments. In some embodiments, the other additive components collectively make up at least 0.2 weight percent of the coating components in the composition (excluding solvent) or at least 0.5 weight percent or at least 1 weight percent. In some embodiments, the other additive components collectively make up at most 20 weight percent of the coating components in the composition (excluding solvent) or at most 10 weight percent or at most 5 weight percent.

### Aqueous Composition and Method of the Present Invention

In some embodiments, the aqueous compositions of the present invention contain at least 20 weight percent coating components or at least 30 weight percent or at least 40 weight percent or at least 50 weight percent. In some embodiments, the aqueous compositions of the present invention contain at most 80 weight percent coating components or at most 75 weight percent or at most 70 weight percent. In some embodiments, the aqueous compositions of the present invention contain at least 20 weight percent aqueous solvent or at least 25 weight percent or at least 30 weight percent. In some embodiments, the aqueous compositions of the present invention contain at most 80 weight percent aqueous solvent or at most 70 weight percent or at most 60 weight percent or at most 50 weight percent.

In the method of the present invention, the aqueous composition is applied to the surface of a roof and dried to form a solid coating adhered to the top surface of the roof. In some embodiments, the roof pitch is less than 15 degrees from horizontal or less 10 degrees or less than 5 degrees. In some embodiments, the overall roof pitch is essentially horizontal.

The roof surface may optionally comprise known materials, such as shingles, ceramic tiles, metal roofing, a polymer membrane or tar and gravel. In some embodiments, the roof surface comprises a membrane, such as ethylene propylene diene terpolymer (EPDM), thermoplastic polyolefin (TPO) or polyvinyl chloride.

The aqueous composition may be applied to the roof surface by known means such as spraying, rolling or brushing. As with other aqueous outdoor coatings, it would commonly be applied during dry weather with a temperature high enough for the aqueous solvent to evaporate quickly leaving the dry coating behind. In some embodiments, the temperature will be at least 10° C. or 12° C. or at least 15° C. or at least 20° C. or at least 23° C.

The aqueous composition is allowed to dry, leaving behind a solid dried coating on top of the roof surface. As with other aqueous outdoor coatings, the aqueous composition may be applied as a single coat, or two or more coats may be applied with each coat permitted to substantially dry before the next coat is applied.

The contents of the dry coating are essentially the same as the coating components of the aqueous composition. In some embodiments, the dry coating comprises no more than 5 weight percent solvent, or no more than 3 weight percent or no more than 1 weight percent or no more than 0.5 weight percent. There is no required content of solvent in the coating but in some cases it may be impractical to remove solvent to a content below 0.01 weight percent. There is no requisite thickness for the coating, but in some embodiments the average thickness of the coating is at least 100 μm or at least 250 μm or at least 400 μm and in some embodiments the average thickness is at most 1000 μm or at most 800 μm or at most 600 μm.

The non-toxic antifouling additive prevents molds, mildews and other organism from anchoring onto the coating. As a result, the organisms cannot grow well and fouling on the coated portions of the roof are reduced.

In some embodiments, the tensile strength of the dried coating (measured as described in the test methods) is at least 50 psi or at least 60 psi or at least 80 psi or at least 100 psi. There is no maximum desired tensile strength, but tensile strength above 500 psi is often unnecessary. In some embodiments, the elongation-to-break of the dried coating (measured as

described in the test methods) is at least 120% or at least 150% psi or at least 180% or at least 200%. There is no maximum desired elongation-to-break, but elongation-to-break above 400% is often unnecessary.

In some embodiments, the dry adhesion of the dried coating to steel (measured as described in the test methods) is at least 2.5 p/li or at least 3 p/li or at least 3.5 p/li or at least 4 p/li. There is no maximum desired adhesion.

In some embodiments, the 7-day water absorption of the dried coating (measured as described in the test methods) is at most 20 weight percent or at most 16 weight percent or at most 15 weight percent. There is no maximum desired minimum water absorption, but absorption below 5 weight percent may be difficult to achieve.

The invention is demonstrated by the following examples, which do not limit the full scope of the invention.

### EXAMPLES

### Test Methods

ASTM D903 Test Method for Peel of Stripping Strength of Adhesive Bonds—Used for measurements of coating adhesion to roofing substrates
ASTM D1653 Test Method for Water Vapor Transmission of Organic Coating Films—Used for water permeability measurements
ASTM D471 Test Method for Rubber Property−Effect of Liquids—Used for water absorption measurements
ASTM D2370 Test Method for Tensile Properties of Organic Coatings—Tensile and Elongation testing
ASTM D4283 Test Method for Viscosity of Silicone Fluids—Used to measure viscosity of silicone fluids that are emulsified in water
ASTM D3719 Test Method for Quantifying Dirt Collection on Coated Exterior Panels

### Binder Emulsion (“Binder Emulsion 1”)

An acrylic binder emulsion is made that mimics a typical roof coating binder, except the emulsion excludes a biocide to prevent the biocide from interfering with further tests.

A reactor is prepared by adding deionized water (372.5 g) and Na₂CO₃ (0.5 g) to a 3000 mL 4-neck round bottom flask fitted with a condenser, overhead stirrer, and thermocouple. The contents of the reactor are stirred and heated to 83° C. under nitrogen atmosphere.

A monomer emulsion is prepared in a separate vessel. Deionized water (222.6 g), Polystep A-16-22 surfactant (5.8 g, 22.0% active in water) and butyl acrylate monomer (272.1 g) are blended. Additional charges of butyl acrylate (642.1 g), methyl methacrylate (132.1 g), methacrylic acid (17.7 g) and benzophenone (2.9 g) are added to the vessel with mixing. Aqueous sodium persulfate (3.0 g in 18.2 g deionized water), 30% aqueous ammonia (1.5 g in 2.5 g water) and a 100 nm preform emulsion polymer seed (52 wt-% methylmethacrylate, 46.7 wt-% butyl acrylate and 1.3 wt-% methacrylic acid at 45% solids content) (52.9 g) are added to the reactor, followed by deionized water (13.6 g) used to rinse out the raw material containers.

The monomer emulsion and a solution of sodium persulfate (1.7 g in 52.9 g water) are fed simultaneously into the reactor over 90 min, at a temperature of 79-83° C. At about 36 minutes into the feeding process (about 40% of the monomer emulsion added), a 21.4 g quantity of 2-ethyleneurea ethyl methacrylate is added to the remaining monomer emulsion vessel with mixing and rinsed with deionized water (4.5 g). Upon completion of the feeds, the temperature is held at 82-83° C. for an additional 30 min. Next, 30% aqueous ammonia (1.2 g diluted with 27.2 g water), VERSENE™ chelating agent (0.27 g, 1% active in H2O), and FeSO₄ (aq) (2.7 g, 0.15% active in water) are successively added to the reactor. Next, 70% t-butyl hydroperoxide in water (0.8 g diluted in 25.1 g of water) and sodium formaldehyde sulfoxylate (0.94 g in 25.1 g of water) are fed into the reactor concurrently over 60 min. After the first 30 min the reactor is cooled to 75° C. After all the feeds are added, the reactor is cooled to 45° C. and 30% aqueous ammonia (4.0 g diluted with 7.0 g water) are added dropwise. The reactor is cooled to room temperature, and the aqueous dispersion is filtered. The final polymer dispersion has 54.7% solid content and a Z average particle diameter of 275.2 nm, as determined by dynamic light scattering using a Malvern Zetasizer. The dispersion is called “Binder Latex 1”.

### Base Emulsion Coating Composition

A base latex coating composition that contains Binder Emulsion 1 is prepared in a 2L stainless steel grind pot with agitation using a high-speed mixer equipped with a 2-inch Cowles sawtooth blade. The grind ingredients of Table 1 below are added to the pot in the order listed with the mixer set to 200 rpm. The mixer is set to 2000 rpm and the grind is mixed for 20 minutes. The agitation is reduced to 500 rpm and the remaining letdown ingredients are added in the order listed. The contents are mixed at 500 rpm for 20 minutes, until the latex coating composition has a smooth uniform consistency.

TABLE 1
Formulation Ingredients for the Elastomeric Roof Coating.

| | Type | Grams |
|---|---|---|
| Grind Ingredient | | |
| Water | Water | 304.00 |
| Tamol 901 | Dispersants | 17.00 |
| DEE FO ™ 1015 | Defoamers | 3.00 |
| Snowhite 12 | Calcium Carbonate Filler | 900.00 |
| Ti-Pure R-960 | Pigments | 150.00 |
| End Grind | | 1374.00 |
| LetDown Ingredient | | |
| Binder Emulsion 1 | Latex Binder | 950.00 |
| DEE FO ™ 1015 | Defoamer | 3.00 |
| UCAR ™ Filmer IBT | Coalescent | 10.00 |
| Ammonia (28%) | Neutralizing Agent | 2.00 |
| Propylene Glycol | Solvents | 28.00 |
| WALOCEL ™ MT 30000 PV | Thickeners | 7.20 |
| Water | Water | 15.66 |
| End LetDown | | 1015.86 |
| Totals | | 2389.86 |

### Example 1: Coating With PDMS Emulsion

A series of polydimethylsiloxane with differing viscosities, which correspond to different molecular weights, are formulated into emulsions.

### Emulsion Containing PDMS Fluid With 5 cSt Viscosity

The following ingredients are added to a 600 gram stainless steel beaker: 75.0 grams of water, 11.7 grams of Lutensol XP-79 nonionic surfactant, and 2.76 grams of Hostapur SAS-30 anionic surfactant. This mixture is blended with a Lightnin' mixer fitted with a propeller and Cowle's blade at low speed (150 RPM) to incorporate the surfactant without creating foam. A 207.5 grams portion of XIAMETER™ PMX-200 silicone fluids having a viscosity of 5 cSt. (PDMS) is added slowly with increased mixing as to minimize foam generation. This mixture is then stirred for 15 minutes at 500 RPM. The resulting emulsion is placed into a Speedmixer cup with a small hole in the lid and spun at 3500 RPM to remove the air. The resulting emulsion is 69 weight % silicone and has an average particle diameter of 1.24 μm.

### Emulsion Containing PDMS Fluid With 100 and 350 cSt Viscosity

The following ingredients are added to a 3.5 kg stainless steel beaker: 500.0 grams of water, 78.0 grams of Lutensol XP-79 nonionic surfactant, and 18.48 grams of Hostapur SAS-30 anionic surfactant. This mixture is blended with a Lightnin' mixer fitted with a 45 degree pitched blade on top and a 90 degree on bottom, at low speed (150 RPM) to incorporate the surfactant without creating foam. 1400 grams of XIAMETER™ PMX-200 silicone fluids (either 100 or 350 cSt). (PDMS) is then slowly added with increased mixing as to minimize foam generation. This mixture is finally stirred for 45 minutes at 500 RPM. The resulting emulsion is sheared through a Sonolator homogenizer at 1700 PSI. The resulting emulsion is 70.1% weight silicone and has an average particle diameter close to 0.4 μm.

### Emulsion Containing PDMS Fluid With 5000, 60000, 300000, and 2.5 MM cSt Viscosity

The following ingredients are added to a DAC100 Speedmixer cup: 70.0 grams of XIAMETER™ PMX-200 silicone fluids (either 5000, 60000, 300000, and 2.5 MM cSt viscosity) (PDMS), 3.90 grams of Lutensol XP-79 nonionic surfactant, and 0.92 grams of Hostapur SAS-30 anionic surfactant and 0.91 grams of water. This mixture is blended with a DAC150 Speedmixer as max speed (3500 RPM for 30 seconds). Subsequent dilutions of 4.20, 9.80, and 10.10 grams of water are added with spinning after each. The resulting emulsion are 70-78 weight percent silicone and have an average particle diameter ranging between 0.23 and 6.8 μm depending on the polymer viscosity.

The different emulsions are summarized in Table 2

TABLE 2

| | Viscosity | Molecular | | |
|---|---|---|---|---|
| PDMS | of PDMS | Weight of PDMS | Particle | |
| Emulsion | Fluid Used | Fluid Used for | Size (μm) | Percent |
| Sample | for Emulsion | Emulsion (Da) | DV50 | Silicone |
| 1 | 5 | 770 | 1.24 | 69 |
| 2 | 100 | 5,970 | 0.37 | 70 |
| 3 | 350 | 13,650 | 0.44 | 70 |
| 4 | 5,000 | 49,350 | 0.23 | 70 |
| 5 | 60,000 | 116,500 | 0.75 | 70 |
| 6 | 300,000 | 204,000 | 1.65 | 70 |
| 7 | 2,500,000 | 423,000 | 6.79 | 78 |

For each of the emulsion samples above, 500 g of base latex coating composition is mixed using an overhead mixer at an rpm sufficient to generate a small vortex in the coating. The PDMS emulsion is added dropwise in an amount shown in Table 3, and then the coating composition is mixed for an additional 5 minutes. The composition of each coating and properties of each coating formulation are shown in Table 3.

In addition, a comparative example (CE1) is prepared without the addition of PDMS emulsion.

A sample (11-15 g) of each freshly prepared Roof Coating (ERC) formulations is added to three different sterile polystyrene petri dishes (Fisher Scientific (FB0875712)). As a comparative, 3 dishes are coated with the roof coating formulation that has no PDMS Emulsion. The coating is uniformly distributed in each dish by tapping the dish on a flat surface. The dishes are allowed to cure for 2 weeks at 75 F and 50% relative humidity. After curing, the coatings are disinfected using isopropanol. The dishes are allowed to dry overnight to ensure complete evaporation of the solvent.

Inoculation, growth experiments, and photography are performed in a Biosafety Level 2 (BSL-2) lab. An inoculant mixture is prepared. A stock solution of BG-11 broth (Sigma Aldrich) is diluted using sterile deionized water by 100 times. The diluted solution is sterilized by autoclaving, cooled to room temperature (RT) before being stored in a refrigerator at 4° C. Four environmental isolate samples of roof algae are obtained. Within a biological safety cabinet, 500 μL of each of the four algal strains is added to a sterile vial. A BG-11 solution (1%, 10 mL), at room temperature, is added to this vial and the mixture is swirled until well mixed.

A 200 μL sample of the inoculant mixture is added to each petri dish, along with a 20 ml sample of the 1% BG-11 broth solution. The petri dishes are gently swirled to blend the contents and a photo is taken of each dish. Pictures are taken with a Nikon D80 digital SLR camera. Samples are illuminated with an LED light to give a reading of 1270 lumens at the coating surface as measured with a handheld light meter. The camera settings are: shutter speed= 1/1000 sec, F-Stop=5.6, White Balance=5 (Daywhite fluorescent), ISO=1600. The same lighting and camera setting are used for all pictures to allow comparison of photos taken at different time points. Each dish is stored for 8 weeks in a timed light box (daylight spectrum light, 12 hours of light per 24 hour period) with about 100 percent relative humidity. The BG-11 growth media is refreshed every 3 weeks. Once per week, a new photo is taken of each dish.

After 8 weeks, algal growth in each petri dish is measured based on color change. Each weekly image of the dish is compared to the 0 week image and analyzed using image analysis software to quantify the change in color on the coating using the CIELAB system. Each dish is divided into nine areas and the average L, a, and b values of each region are computed using image analysis software. The change in color for each region of the coating is given by

$$Δ Ei = √ ( {( {L}_{i} - {L}_{0} )}^{2} + {( {a}_{i} - {a}_{0} )}^{2} + {( {b}_{i} - {b}_{0} )}^{2} )$$

Where Lᵢ, aᵢ and bᵢ are values obtained in a specific week after inoculation; and L₀, a₀ and b₀ are the corresponding values obtained at week 0. The mean ΔE over all nine areas represents the average change in color for that dish. The results are shown in Tables 4A (inventive examples) and 4B (Comparative Examples). Larger values of ΔE indicate greater biofilm growth. ΔE values that are less than 10 show minimal growth (growth is difficult to see with the naked eye). Values greater than 30 indicate a substantial biofilm colonization, and values greater than 50 indicate a total coverage of the coating.

In addition, a sample of each coating is brushed on concrete, polyurethane and metal (18-24 sq-in. coatings having a coating of 18-20 g/sq-in.) and dried. The following qualities of the coating are measured: tensile strength, elongation to break, surface adhesion, water absorption, water permeance and dirt pickup. The results are shown in Tables 5-9.

TABLE 3

| | Mass | Mass | Solids % | Viscosity of | PDMS Mass | Mass % PDMS |
|---|---|---|---|---|---|---|
| | % Base | % PDMS | of Base | PDMS Fluid | % in PDMS | in Coating |
| | Emulsion | Emulsion | Coating | (cSt) | Emulsion | Components |
| IE1 | 95 | 5 | 65 | 5000 | 70 | 5.7 |
| IE2 | 95 | 5 | 65 | 60,000 | 70 | 5.7 |
| IE3 | 95 | 5 | 65 | 300,000 | 70 | 5.7 |
| IE4 | 95 | 5 | 65 | 350 | 70 | 5.7 |
| IE5 | 95 | 5 | 65 | 100 | 70 | 5.7 |
| IE6 | 95 | 5 | 65 | 2.500,000 | 78 | 6.3 |
| IE7 | 95 | 5 | 65 | 5 | 69 | 5.6 |
| IE8 | 85 | 15 | 65 | 5000 | 70 | 19.0 |
| IE9 | 85 | 15 | 65 | 60,000 | 70 | 19.0 |
| IE10 | 85 | 15 | 65 | 300,000 | 70 | 19.0 |
| IE11 | 85 | 15 | 65 | 2,500,000 | 78 | 21.2 |
| IE12 | 85 | 15 | 65 | 350 | 70 | 19.0 |
| IE13 | 85 | 15 | 65 | 5 | 69 | 18.7 |
| IE14 | 85 | 15 | 65 | 100 | 70 | 19.0 |
| CE1 | 100 | 0 | 65 | — | — | — |
| CE2 | 96.9 | 3.1 | 65 | 5000 | 70 | 3.4 |
| CE3 | 97 | 3 | 65 | 60,000 | 70 | 3.3 |
| CE4 | 97 | 3 | 65 | 300,000 | 70 | 3.3 |
| CE5 | 97 | 3 | 65 | 350 | 70 | 3.3 |
| CE6 | 97 | 3 | 65 | 100 | 70 | 3.3 |
| CE7 | 99 | 1 | 65 | 5000 | 70 | 1.1 |
| CE8 | 99 | 1 | 65 | 60,000 | 70 | 1.1 |
| CE9 | 99 | 1 | 65 | 300,000 | 70 | 1.1 |
| CE10 | 99 | 1 | 65 | 350 | 70 | 1.1 |
| CE11 | 99 | 1 | 65 | 100 | 70 | 1.1 |

### Table 4. Delta E Values From Biofilm Growth Test for Inventive and Comparative Examples

TABLE 4A
Biofilm Growth on Inventive Examples

| | IE1 | IE2 | TE3 | IE4 | TE5 | IE6 | IE7 | IE8 | IE9 | IE10 | IE11 | IE12 | IE13 | IE14 |
|---|---|---|---|---|---|---|---|---|---|---|---|---|---|---|
| Mass % PDMS Emulsion | 5 | 5 | 5 | 5 | 5 | 5 | 5 | 15 | 15 | 15 | 15 | 15 | 15 | 15 |
| PDMS Fluid Visc. (cSt) | 5K | 60K | 300K | 350 | 100 | 2,500K | 5 | 5K | 60K | 300K | 2,500K | 350 | 5 | 100 |
| Week 1 ΔE | 0.4 | 0.5 | 0.7 | 0.7 | 0.6 | 0.6 | 0.7 | 0.5 | 1.0 | 0.8 | 0.8 | 0.6 | 0.8 | 0.6 |
| Week 2 ΔE | 0.6 | 0.7 | 2.5 | 1.2 | 0.6 | 2.8 | 2.3 | 0.5 | 0.8 | 0.7 | 0.8 | 0.6 | 0.9 | 0.8 |
| Week 3 ΔE | 1.7 | 2.1 | 6.2 | 5.5 | 0.5 | 4.1 | 7.9 | 0.6 | 0.9 | 0.8 | 0.8 | 0.8 | 1.1 | 0.9 |
| Week 4 ΔE | 3.1 | 7.3 | 13.4 | 11.3 | 2.9 | 15.3 | 10.1 | 0.6 | 4.5 | 0.5 | 0.7 | 0.6 | 1.1 | 0.5 |
| Week 5 ΔE | 7.1 | 9.7 | 17.4 | 11.6 | 4.6 | 28.3 | 18.7 | 1.3 | 8.5 | 0.6 | 0.7 | 1.2 | 1.9 | 0.9 |
| Week 6 ΔE | 6.0 | 8.1 | 12.4 | 9.0 | 7.0 | 30.0 | 25.3 | 1.4 | 10.1 | 0.6 | 0.8 | 1.5 | 3.3 | 0.7 |
| Week 7 ΔE | 4.6 | 5.9 | 10.5 | 6.5 | 5.4 | 27.1 | 24.2 | 1.1 | 10.5 | 0.6 | 0.5 | 0.8 | 5.1 | 0.5 |
| Week 8 ΔE | 3.8 | 4.3 | 9.2 | 5.2 | 3.4 | 24.9 | 22.4 | 1.0 | 10.2 | 0.9 | 1.1 | 1.2 | 5.8 | 0.9 |

TABLE 4B
Biofilm Growth on Comparative Examples

| | CE1 | CE2 | CE3 | CE4 | CE5 | CE6 | CE7 | CE8 | CE9 | CE10 | CE11 |
|---|---|---|---|---|---|---|---|---|---|---|---|
| Mass % PDMS Emulsion | 0 | 3.1 | 3 | 3 | 3 | 3 | 1 | 1 | 1 | 1 | 1 |
| PDMS Fluid Visc. (cSt) | n/a | 5K | 60K | 300K | 350 | 100 | 5K | 60K | 300K | 350 | 100 |
| Week 1 ΔE | 2.6 | 1.2 | 1.2 | 1.9 | 1.3 | 1.0 | 1.2 | 1.7 | 1.0 | 1.4 | 3.3 |
| Week 2 ΔE E | 19.8 | 4.0 | 4.1 | 3.0 | 3.5 | 3.9 | 3.9 | 3.8 | 3.8 | 3.5 | 21.3 |
| Week 3 ΔE E | 21.3 | 16.9 | 7.4 | 27.5 | 5.2 | 9.1 | 6.8 | 6.5 | 8.3 | 6.5 | 28.0 |
| Wcck 4 ΔE | 54.9 | 54.2 | 38.2 | 32.6 | 6.4 | 8.5 | 7.3 | 6.2 | 7.2 | 8.0 | 24.2 |
| Week 5 ΔE | 57.2 | 71.9 | 50.1 | 39.5 | 7.3 | 17.9 | 27.1 | 8.8 | 17.0 | 18.6 | 31.9 |
| Week 6 ΔE | 64.0 | 69.6 | 48.8 | 65.5 | 23.8 | 53.7 | 67.1 | 39.6 | 65.4 | 46.1 | 54.1 |
| Week 7 ΔE | 55.7 | 67.8 | 48.7 | 66.4 | 56.4 | 58.4 | 67.1 | 54.5 | 63.3 | 53.2 | 54.3 |
| Week 8 ΔE | 51.2 | 67.6 | 48.8 | 65.6 | 63.9 | 64.1 | 67.7 | 58.1 | 64.7 | 56.4 | 58.5 |

TABLE 5
Tensile and Elongation Results for Elastomeric Roof Coatings

| | Mass | PDMS Fluid | Maximum | Elongation |
|---|---|---|---|---|
| | % PDMS | Viscosity | Tensile | at Break |
| | Emulsion | (cSt) | Strength (psi) | (%) |
| CE1 | 0 | — | 163.8 | 248.8 |
| IE1 | 5 | 5K | 120.0 | 217.1 |
| IE2 | 5 | 60K | 121.5 | 233.9 |
| IE4 | 5 | 350 | 120.5 | 226.1 |
| IE5 | 5 | 100 | 119.8 | 229.4 |
| IE8 | 15 | 5K | 62.9 | 268.3 |
| IE9 | 15 | 60K | 61.5 | 262.5 |
| IE10 | 15 | 300K | 61.7 | 217.1 |
| IE11 | 15 | 2500K | 55.4 | 142.2 |
| IE12 | 15 | 350 | 61.5 | 246.0 |
| IE13 | 15 | 5 | 57.8 | 221.3 |
| IE14 | 15 | 100 | 61.0 | 257.0 |

The tests show that the Inventive Examples retain physical properties useful for roof coatings as compared to a coating without PDMS. In particular, elongation to break is not substantially changed by the additive.

TABLE 6
Adhesion Data for Elastomeric Roof Coatings
(p/li = pounds force per linear inch)

| | CE1 | IE1 | IE3 | IE4 |
|---|---|---|---|---|
| Dry Adhesion to Spray Polyurethane | 5.06 | 3.21 | 3.65 | 4.27 |
| Foam (p/li) | | | | |
| Standard Deviation | 1.52 | 0.21 | 0.41 | 1.01 |
| Failure Mode | C | C | C | C |
| Wet Adhesion to Spray Polyurethane | 1.97 | 1.2 | 1.67 | 1.69 |
| Foam (p/li) | | | | |
| Standard Deviation | 0.29 | 0.19 | 0.37 | 0.42 |
| Failure Mode | C | C | C | C |
| Dry Adhesion to Concrete (p/li) | 5.32 | 3.425 | 3.9 | 3.96 |
| Standard Deviation | 1.64 | 0.15 | 1.33 | 1.64 |
| Failure Mode | C | C | C | C |
| Wet Adhesion to Concrete (p/li) | 0.5 | 0.59 | 0.86 | 1.54 |
| Standard Deviation | 0.11 | 0.12 | 0.21 | 0.42 |
| Failure Mode | A | A/C | A | C |
| Dry Adhesion to Galvanized Steel (p/li) | 3.9 | 4.05 | 3.42 | 2.86 |
| Standard Deviation | 0.21 | 1.11 | 0.49 | 0.05 |
| Failure Mode | C | C | C | C |
| Wet Adhesion to Galvanized Steel (p/li) | 1.88 | 1.41 | 1.18 | 1.13 |
| Standard Deviation | 0.05 | 0.5 | 0.03 | 0.16 |
| Failure Mode | C | C | C | C |

C = Cohesive failure of the coating
A = Adhesive failure of the coating to the substrate

The tests show that Inventive Examples retain useful adhesion to roofing substrates, as compared with coatings that do not contain PDMS.

TABLE 7
Water Absorption

| | CE1 | IE1 | IE2 | IE4 | IE8 | IE9 | IE10 | IE11 |
|---|---|---|---|---|---|---|---|---|
| 7 day Water | 17.5 | 15.1 | 13.5 | 15.3 | 13.4 | 12.6 | 14.7 | 12.3 |
| Absorption | | | | | | | | |
| (% by mass) | | | | | | | | |

TABLE 8
Water Permeance Results for Elastomeric Roof Coatings

| | CE1 | IE1 | IE2 | IE4 | IE12 | IE9 | IE12 |
|---|---|---|---|---|---|---|---|
| Water | 7.2 | 10.0 | 10.3 | 12.4 | 11.0 | 21.4 | 11 |
| Permeance | | | | | | | |
| (perms) | | | | | | | |

TABLE 9
Dirt Pickup Resistance for Elastomeric Roof Coatings.

| | CE1 | IE1 | IE2 | IE3 | IE4 | IE5 |
|---|---|---|---|---|---|---|
| Y Reflectance | 98.8 | 98.4 | 95.2 | 95.5 | 99.8 | 99.8 |
| Retained with UV (%) | | | | | | |
| Y Reflectance | 91.1 | 88.8 | 89.3 | 90.5 | 91.2 | 91.7 |
| Retained w/o UV (%) | | | | | | |

| | IE8 | IE9 | IE10 | IE11 | IE12 | IE13 | IE14 |
|---|---|---|---|---|---|---|---|
| Y Reflectance | 100.5 | 98.0 | 92.2 | 64.3 | 99.2 | 98.1 | 98.8 |
| Retained with UV (%) | | | | | | | |
| Y Reflectance | 90.1 | 88.4 | 90.4 | 79.8 | 90.0 | 91.1 | 86.6 |
| Retained w/o UV (%) | | | | | | | |

Tables 7, 8 and 9 show that the inventive examples retain useful properties for roof coatings, as compared to coatings that contain no PDMS.

### Example 2: Coatings That Contain Cross-Linked Silicone Rubbers

Commercially-available silicone rubber dispersions are blended with the Base Emulsion Coating Composition as shown in Table 10, to make coating compositions for Inventive Examples IE 15-26. The procedures for coating petri dishes, inoculating the dishes, growing the cultures and testing the dishes is repeated as in Example 1. A Comparative Example CE 11 that contains no silicone rubber is also made and tested. The results are shown in Table 10.

TABLE 11

| | | | | | | | | | | | |
|---|---|---|---|---|---|---|---|---|---|---|---|
| CE11 | IE15 | IE16 | IE17 | IE18 | IE19 | IE20 | IE21 | IE22 | IE23 | IE24 | IE25 |

Contents of Blended Coating Compositions

| | | | | | | | | | | | | |
|---|---|---|---|---|---|---|---|---|---|---|---|---|
| Mass % Binder | 100 | 50 | 52 | 85 | 85 | 85 | 80 | 50 | 90 | 80 | 70 | 50 |
| Emulsion 1 | | | | | | | | | | | | |
| Mass % Silicone | 0 | 50 | 48 | 15 | 15 | 15 | 20 | 50 | 10 | 20 | 30 | 50 |
| Rubber Emulsion | | | | | | | | | | | | |
| Identity of Silicone | | B | A | A | A | C | A | B | B | B | B | B |
| Rubber Emulsion | | | | | | | | | | | | |

Biofouling Test Results

| | | | | | | | | | | | | |
|---|---|---|---|---|---|---|---|---|---|---|---|---|
| Week 1 ΔE | 12.35 | 1.45 | 6.35 | 2.47 | 4.16 | 6.51 | 4.02 | 1.92 | 0.59 | 0.46 | 0.65 | 0.55 |
| Week 2 ΔE | 58.02 | 3.46 | 8.88 | 2.61 | 2.30 | 6.16 | 3.76 | 2.60 | 0.58 | 0.25 | 0.33 | 0.31 |
| Week 3 ΔE | 53.77 | 3.06 | 9.68 | 3.74 | 2.27 | 5.56 | 4.29 | 2.87 | 1.30 | 0.58 | 0.75 | 0.75 |
| Weck 4 ΔE | 59.31 | 6.77 | 11.25 | 5.48 | 5.36 | 5.85 | 5.3 | 2.44 | 2.85 | 1.10 | 0.75 | 0.83 |
| Week 5 ΔE | 45.86 | 6.66 | 9.68 | 4.2 | 6.01 | 8.54 | 4.72 | 2.51 | 2.67 | 0.91 | 0.89 | 0.58 |
| Week 6 ΔE | 59.66 | 6.27 | 10.82 | 5.2 | 5.94 | 7.41 | 5.75 | 2.50 | 4.97 | 4.46 | 4.54 | 4.44 |
| Week 7 ΔE | 62.10 | 19.13 | 11.11 | 15.74 | 20.95 | 25.13 | 18.76 | 2.75 | 4.26 | 3.81 | 3.24 | 2.98 |
| Week 8 ΔE | 56.56 | 7.2 | 14.04 | 7.86 | 8.55 | 11.13 | 8.66 | 2.68 | 7.10 | 6.59 | 6.13 | 6.44 |

A = AllGuard, 3-2345
B = DOWSIL ™ IE 2610,
C = DOWSIL ™ 33

1. A method to protect the roof of a structure, which has an exposed top surface, comprising the steps of:
a) applying to the top surface of the roof an aqueous coating composition that contains the following coating components dissolved or suspended in an aqueous solvent:
i) an acrylic polymer binder in a concentration suitable to form a stable coating,
ii) a non-toxic antifouling additive in a concentration suitable to suppress fouling on the roof, and
iii) from 0 to 80 weight percent other coating components based on the weight of the coating components in the composition, excluding solvent; and
b) drying the aqueous coating composition such that it forms a solid coating adhered to the top surface of the roof.

2. The method of claim 1 wherein the acrylic polymer binder has a glass-transition temperature no higher than 0° C. and at least one of the other coating components is selected from the group consisting of pigments, fillers, thickeners, surfactants, hydrophobic additives, levelling and coalescing agents, antioxidants and UV stabilizers.

3. The method of claim 2 wherein the acrylic polymer binder has a glass-transition temperature no higher than −20° C.

4. The method of claim 2 wherein the non-toxic antifouling additive comprises a silicon-containing material.

5. The method of claim 4 wherein the non-toxic antifouling additive comprises a polysiloxane.

6. The method of claim 5 wherein the polysiloxane is polydimethylsiloxane

7. The method of claim 5 wherein the polysiloxane makes up from 2 to 10 weight percent of the coating components in the composition, excluding solvent.

8. The method of claim 7 wherein the polysiloxane makes up from 8 to 20 weight percent of the coating components in the composition, excluding solvent.

9. The method of claim 5 wherein the polysiloxane has a weight average molecular weight of at least 5000 Da and most 350,000 Da.

10. The method of claim 4 wherein the non-toxic antifouling additive comprises cross-linked silicone rubber particles.

11. The method of claim 10 wherein the cross-linked silicone rubber particles make up at least 2 weight percent of the coating components in the composition, excluding solvent.

12. The method of claim 10 wherein the cross-linked silicone rubber particles make up at most 20 weight percent of the coating components in the composition, excluding solvent.

13. The method of claim 11 wherein the cross-linked silicone rubber particles have an average particle diameter from at least 0.5 mm to at most 5 mm.

14. An aqueous coating composition, which coating composition comprises the following coating components dissolved or suspended in an aqueous solvent:
a) An acrylic polymer binder that has a glass-transition temperature of no more than 0° C., in a concentration suitable to form a stable coating;
b) a non-toxic antifouling additive in a concentration suitable to suppress fouling on the roof; and
c) from 0 to 80 weight percent other coating components based on the weight of the coating components in the composition, excluding solvent.

15. A structure comprising a roof with an exposed top surface, wherein a solid coating is adhered to the top surface of the roof and the coating contains the following coating components: (a) an acrylic polymer binder that has a glass-transition temperature of no more than 0° C. and binds the coating to the roof; (b) a non-toxic antifouling additive in a concentration suitable to suppress fouling on the roof; and (c) from 0 to 80 weight percent other coating components based on the weight of the coating components in the composition, excluding solvent.
